(19) United States
(12) Patent Application Publication
(10) Pub. No.: US 2017/0307200 A1
(43) Pub. Date: Oct. 26, 2017

(54) LIGHT FIXTURE WITH OPTIMIZED COOLING SYSTEM

(71) Applicant: David K. Booth, Rickreall, OR (US)

(72) Inventor: David K. Booth, Rickreall, OR (US)

(21) Appl. No.: 15/493,078

(22) Filed: Apr. 20, 2017

Related U.S. Application Data
(60) Provisional application No. 62/325,439, filed on Apr. 20, 2016.

(51) Int. Cl. F21V 29/58; F21V 29/89; F21V 29/76; F21V 29/67; F21V 29/83; F21Y 2115/10

(52) U.S. Cl. CPC F21V 29/59; F21V 29/83; F21V 29/89; F21V 29/58; F21V 29/76; F21V 29/673; F21Y 2115/10

(57) ABSTRACT

A light fixture for high temperature lights with a fluid cooling system operably secured thereto designed to provide optimal cooling using minimal resources and materials. The fluid may be air, water, coolant or the like. An improved heat sink positioned between the cooling fluid and the light provides optimal fluid flow geometries and creates at least one of three possible optimized cooling conditions: First, by forcing fluid to rush through one or more restricting apertures its velocity may be increased by the localized pressure drop. Second, by positioning the heat sink heat exchange structure immediately downstream of the restricting apertures and forcing the fluid flow to change direction while within the confines of the heat exchange structure. Third, the fluid flow may be bifurcated to flow bilaterally through both ends of the heat sink at once in parallel.

### CROSS REFERENCE TO RELATED APPLICATION

This application claims priority to U.S. provisional patent application Ser. No. 62/325,439 filed on Apr. 20, 2016, the disclosure of which is hereby incorporated by reference.

### FIELD OF THE INVENTION

The present invention relates to a light fixture with an optimized cooling system. The fixture provides efficient and reliable cooling for lights that operate at high temperatures such as Light Emitting Diode (“LED”) grow lights and the like.

### BACKGROUND

LED lighting systems on the market with cooling components operably secured thereto have had limited success. They tend to use extruded, assembled, or otherwise manufactured heat sinks. Many such products have very large footprints because they have dozens or even hundreds of individual LEDs mounted onto large heat sinks with fans blowing air on or around them. The form factors of existing LED lighting products do not maximize cooling with minimal materials. Current product costs are still well above one dollar per watt and product weights run in the range of 5-10 pounds per 100 watts.

Moreover, they tend to be inefficient and provide limited cooling benefits for the lights and/or consume an excessive amount of energy or other resources to provide the desired cooling effect.

### SUMMARY

Thus, there remains a need for a light fixture for high temperature lights with a fluid cooling system operably secured thereto designed to provide optimal cooling using minimal resources and materials. The fluid may be air, water, coolant or the like. The present invention fulfills these and other needs.

In disclosed embodiments, the invention achieves improved cooling performance with less material by optimizing the heat sink and fluid flow geometries to create at least one of three possible optimized cooling conditions: First, by forcing fluid to rush through one or more restricting apertures its velocity may be increased by the localized pressure drop. Second, by positioning the heat sink heat exchange structure immediately downstream of the restricting aperture(s) and forcing the fluid flow to change direction while within the confines of the heat exchange structure, the heat transfer may be maximized for the available quantities of fluid flow and heat exchange structure area. Third, the fluid flow may be bifurcated to flow bilaterally through both ends of the heat sink at once in parallel.

In a disclosed embodiment, heat sinks are made from short sections of an extra wide thermally conductive extrusion material such as aluminum with extra tall and textured fins to maximize the overall system performance. An equally wide restricting aperture slot positioned along the bases of the fins delivers the air flow most effectively. By employing the thermal conductivity of the extruded material to spread the heat across the entire width of the air flow path the heat exchange is maximized while the air flow resistance is minimized.

By using a plurality of heat sinks with one or more light sources attached to each heat sink, the current invention is intrinsically both scalable and cost effective. This plurality of heat sinks is effectively cooled by a simple air flow plenum design that both balances the cooling between the different heat sinks and spreads and mixes the heat to avoid any hot surface risks.

These and other objects of the inventions are set forth in more detail in the following description and claims.

### FIGURE DESCRIPTIONS

The foregoing Summary and the following Detailed Description will be better understood when read in conjunction with the accompanying figures.

FIG. 1 is a schematic diagram of the cooling fluid flow of an embodiment of the current invention.

FIG. 2 is a cross section schematic view of the cooling fluid flow shown in FIG. 1 showing a possible vacuum-mode of operation.

FIG. 3 is a cross section schematic view of the cooling fluid flow shown in FIG. 1 showing a possible pressure-mode operation.

FIG. 4 is an isometric view of a preferred embodiment heat sink for the current invention for providing the cooling fluid flow of FIG. 1.

FIG. 5 is a top isometric view of a first exemplar light fixture with optimize cooling system in accordance with an embodiment of the present invention.

FIG. 6 is a top view of the light fixture with optimized cooling system of FIG. 5.

FIG. 7 is a cross-section view of the light fixture with optimized cooling system of FIG. 5 taken along line 7-7 of FIG. 6.

FIG. 8 is a cross-section view of the light fixture with optimized cooling system of FIG. 5 taken along line 8-8 of FIG. 7.

FIG. 9 is a top isometric view of a second exemplar light fixture with optimize cooling system in accordance with an embodiment of the present invention.

FIG. 10 is a top view of the light fixture with optimized cooling system of FIG. 9.

FIG. 11 is side view of the light fixture with optimized cooling system of FIG. 9.

FIG. 12 is a front view of the light fixture with optimized cooling system of FIG. 9.

FIG. 13 is a fragmentary isometric top view of the light fixture with optimized cooling system of FIG. 9 showing possible internal detail.

FIG. 14 is a cross-section view of the light fixture with optimized cooling system of FIG. 9 taken along line 14-14 of FIG. 10.

FIG. 15 is a cross section view of the light fixture with optimized cooling system of FIG. 9 taken along line 15-15 of FIG. 11.

FIG. 16 is an enlarged, fragmentary view of a portion of the light fixture with optimized cooling of FIG. 8 showing possible internal detail.

FIG. 17 is a schematic view of a possible cooling liquid flow path for use cooling with a light fixture with optimized cooling in accordance with an embodiment of the present invention.

FIG. 18 is a cross-section view of an extruded thermally conductive material forming flow channels therein for receiving cooling liquid flow therethrough in accordance with an embodiment of the present invention

FIG. 19 is a partial isometric view of an alternative possible light fixture with optimized cooling in accordance with an embodiment of the present invention showing lighting components installed on the extruded thermally conductive material of FIG. 18.

### DETAILED DESCRIPTION

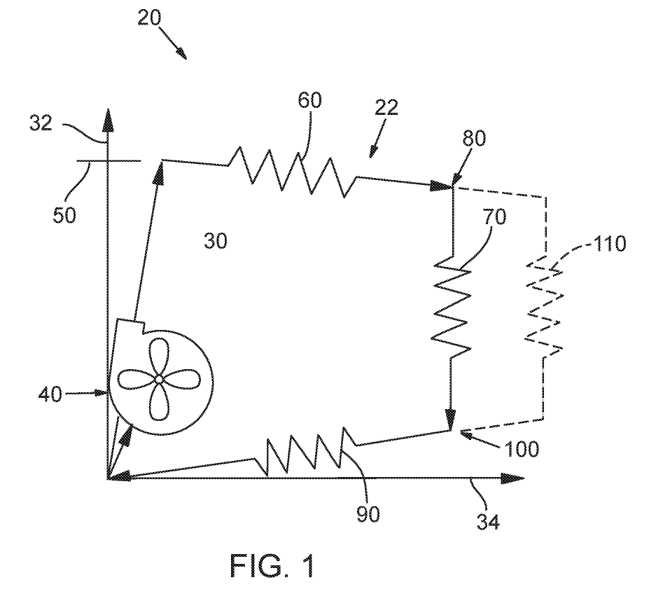

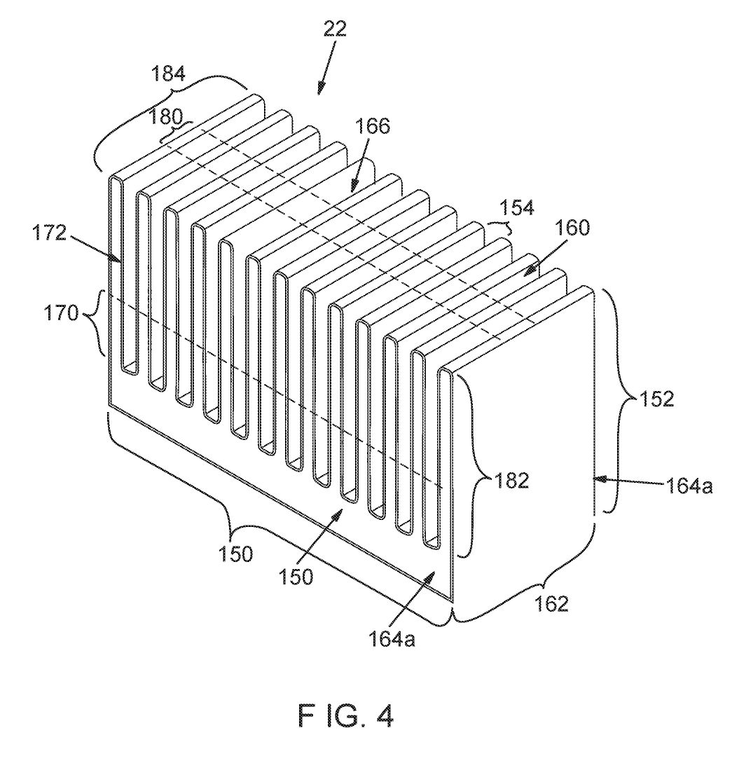

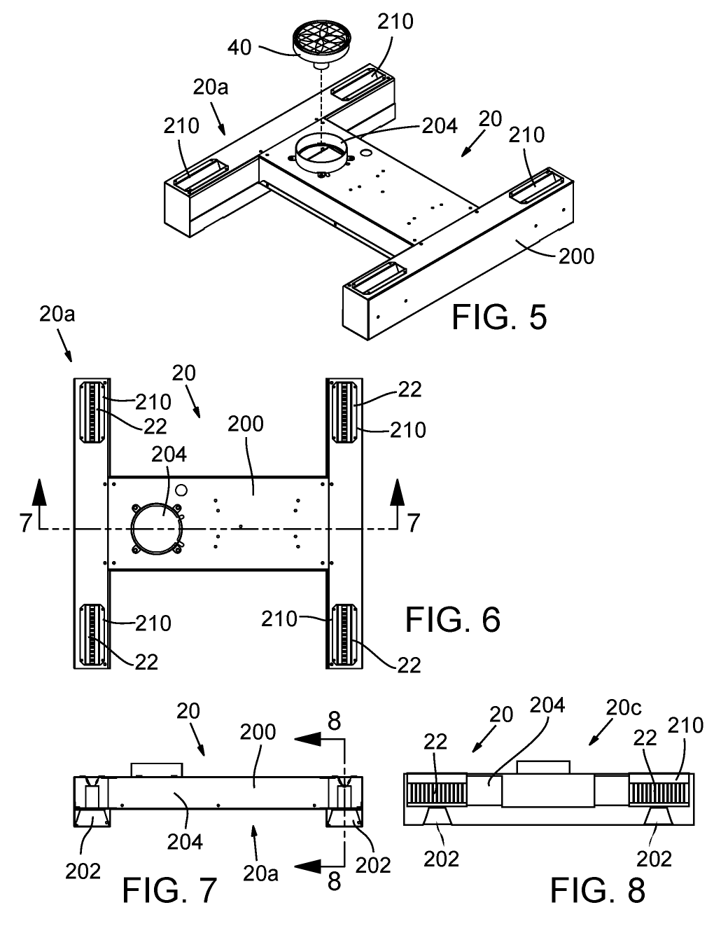

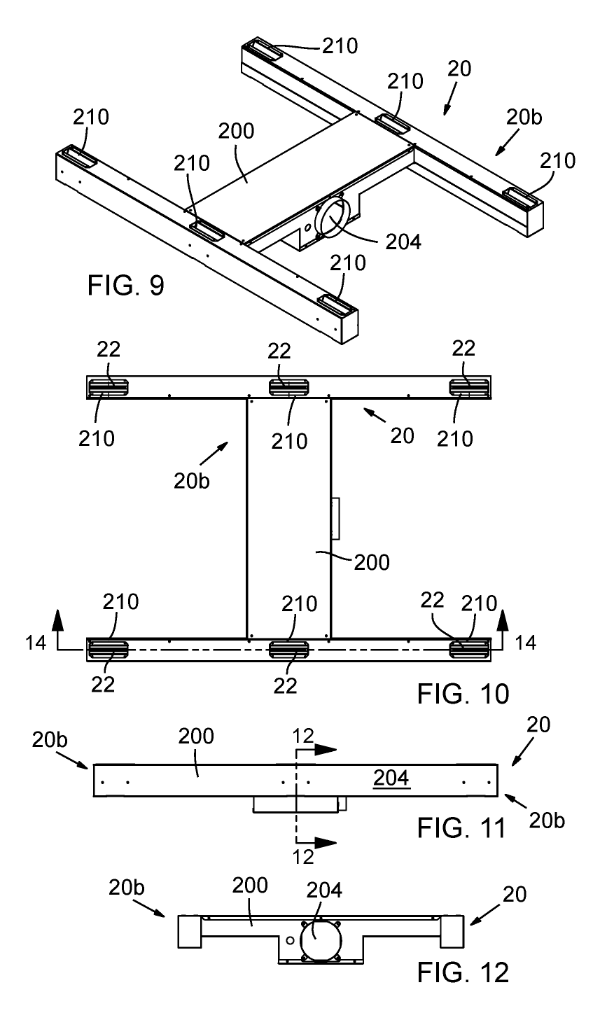

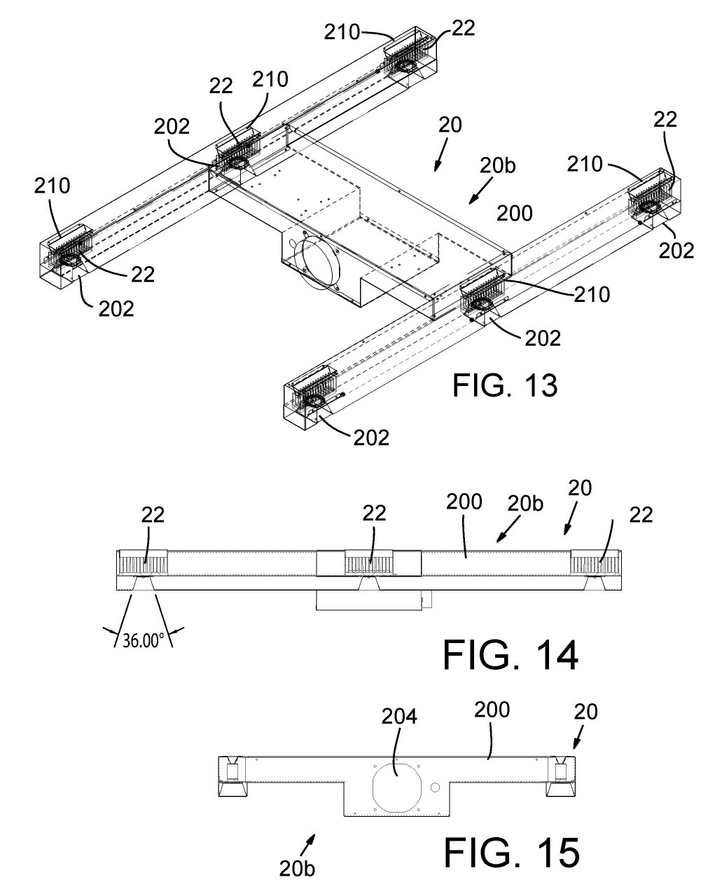

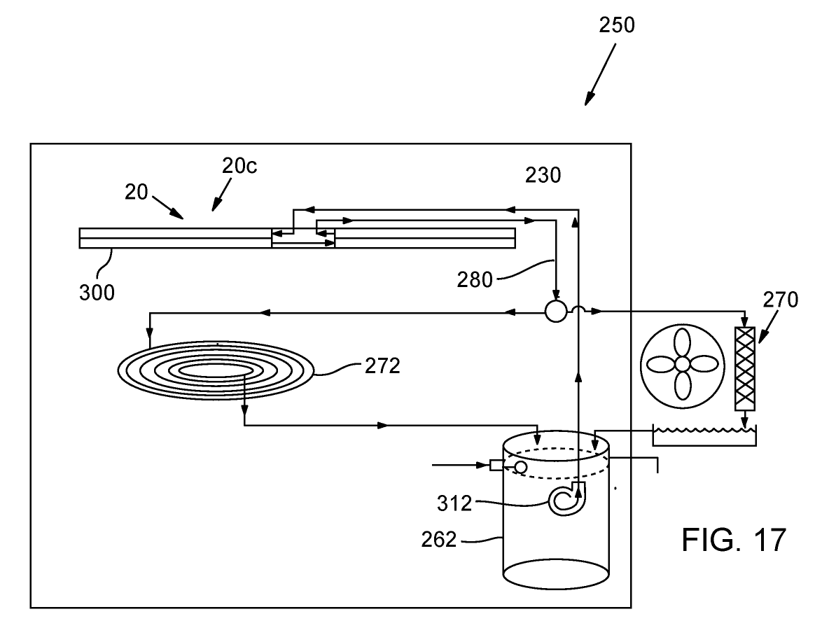

A light fixture with optimized cooling system 20 is shown in FIGS. 1-19. Schematic diagrams of optimized cooling flow paths are shown in FIGS. 1-3. A preferred possible heat sink 22 for providing the optimized cooling flow paths is shown in FIG. 4. A first preferred light fixture 20a is shown in FIGS. 5-8. A second preferred light fixture 20b is shown in FIGS. 9-16, and an alternative preferred cooling system for a third preferred light fixture 20c is shown in FIGS. 17-19. Each of these structures, systems and related components are discussed in greater detail below.

### Optimized Cooling Flow Path

In general, the fluid cooling flow path 30 through the system is optimized by structures within the path that increase the velocity, number of flow paths, and/or promote turbulent flow adjacent to the high temperature light thereby improving the heat exchange therebetween. Referring to FIG. 1, a schematic diagram of the cooling fluid flow path 30, such as air or the like, of the current invention operating in a pressure-mode arrangement is shown. Resistor symbols borrowed from electronic schematics are used to represent the flow head pressure losses of a real fluid cooling system. The flow path 30 is shown as a recirculating circuit even though one of the path legs could be open room air.

FIG. 1 is a graphical representation with a vertical axis 32 representing positive air pressure in the upward direction. FIG. 1 also has a horizontal axis 34 representing the idea that the fan 40 is not necessarily in the same location as the heat exchange structure of the heat sink 36. The head pressure 50 provided by the fan 40 gets dissipated by the pressure-side leg 60 of the air flow path defined by the ductwork enclosure as it travels to the restricting aperture and heat exchange structure 70.

Next, the air flow with its now reduced head pressure 80 rushes through the restricting aperture and heat exchange structure 70 before returning through the vacuum-side leg 90 of the air flow path and completing the circuit loop. By using the open room air as the vacuum-side air path, air flow resistance is minimized and the back-pressure head 100 is likewise minimized thereby providing a maximum pressure drop across the restricting aperture and heat exchange structure.

Drawn as a dashed addition, a second restricting aperture/heat exchange structure 110 is shown in parallel to the first. Its head pressure drop is less than the first due to more duct work path length. It is an intention to provide a relatively uniform flow at each heat sink exchange structure by judiciously limiting the aperture sizes in a similar fashion as is already done in the HVAC field. It is also an intention to eventually create very large air flow cooling networks with up to hundreds of individual heat sinks, each with their own restricting aperture for controlling and balancing the many parallel air flow paths.

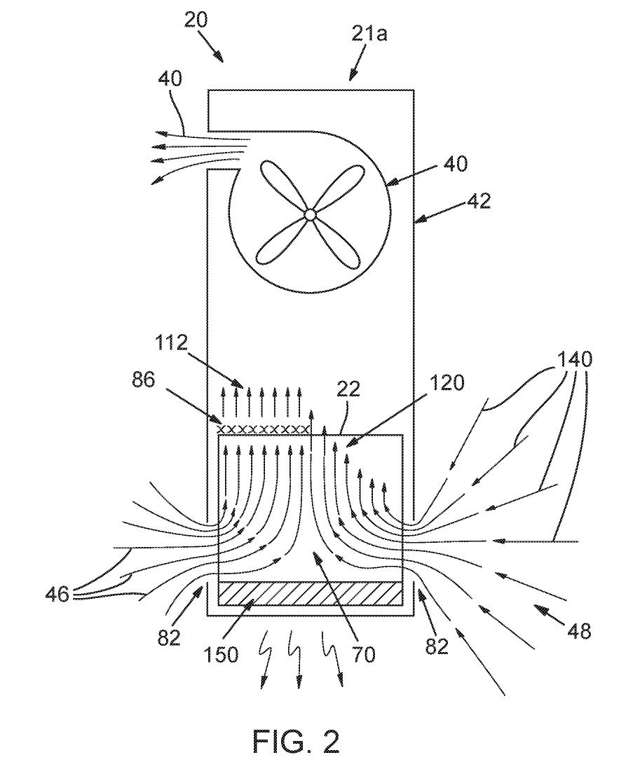

FIG. 2 is a cross section view of the current invention showing how a stand-alone, vacuum-mode operating system 21a of the current invention works. This system is composed of an air moving device, such as a fan 40, moving air from inside the system enclosure or ductwork system 42 to outside the enclosure or ductwork system. This ejected air 44 is replaced by intake air from a first side 46 and a second side 48 which meet while both are inside the heat exchange structure 70 of the heat sink 22.

This intake air flow is controlled and judiciously limited by intentionally designing the shape and size of the restricting apertures 82 and 84 to maximize the overall heat flow. The aperture openings need to be at the bases of the heat exchange fins (in this case) and could generally be less than half the fin height. An improvement can be achieved by adding a porous boundary layer 86 which is shown on the left side of the figure only. The right side shows the same system without the porous boundary layer.

The air flow arrows 112 show how a porous boundary layer can even out the exit air velocity and increase the average air dwell time within the heat exchange structure by adding a slight resistance. In effect, as much of the kinetic energy of the air velocity as possible is turn into useful heat exchange turbulence. Air flow arrows 120 show how the central region could rush out quickly and the top corners could not see as much cooling air flow without the porous boundary layer.

Two measures may be taken to avoid dust build-up anywhere near the light emitting surfaces when designing a vacuum-mode system of the current invention. First, the light emitting surfaces are inverted to shine light 130 downwards from an overhead position thereby employing gravity to keep it clean. Second, the vacuum-mode air flow system begins with relative still air 140 moving by only random migration into the intake apertures of the system. This kind of flow generates a minimum amount of dust-stirring-up turbulence and provides a symmetrical initial momentum direction.

Spreading heat in the third geometric dimension (in and out of the page) is the job of the base 150 of the heat sink. By choosing an extra-wide extrusion shape, this useful heat spreading function adds much more room for longer restricting aperture slots without affecting system costs very much. This also minimizes air resistance.

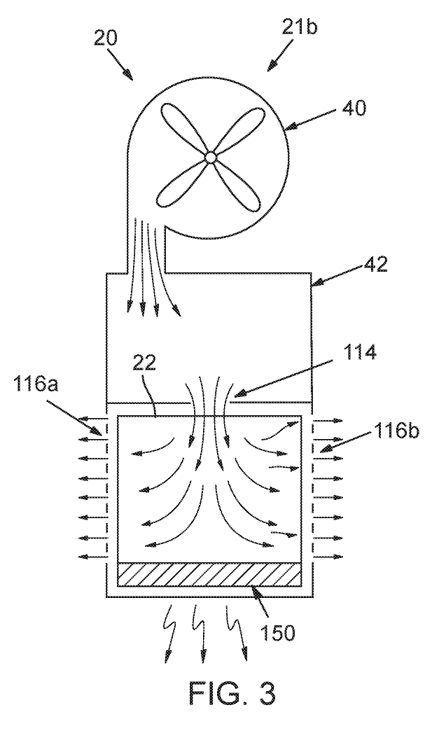

FIG. 3 is a cross section view of the current invention showing a pressure-mode operating system. This system is composed of an air moving device, such as a fan 40, which moves air into the enclosure or ductwork system 42. The air flow is forced to exit through a restricting aperture slot 114 which is located across the center of the top region of a wide format heat sink 22. As described for the vacuum mode system above, the heat sink base 150 is used to spread the heat widely in this last orthogonal dimension.

The air flow speeds up when going through the restricting aperture 114 and then must bifurcate and change direction to exit through the bilateral porous boundaries 116a and 116b. The air velocity is relative uniform when exiting due to the slight resistance of the porous boundary layers.

### Preferred Heat Sink Structure

Referring to FIG. 4, a preferred embodiment heat sink 22 of the current invention is shown. Extruded thermally conductive material such as aluminum is the preferred material for low cost, air cooled systems. Preferred extrusion design features include a very wide extrusion width 150; extra tall heat exchanging fin height 152; wide air spaces 154 to avoid dust build-up over long term use; a thick base 150 for heat spreading across a wide air flow path; and textured heat exchanging fin surfaces 160 for increased heat transfer performance.

The cut lengths 162 are minimized to be at least as wide as the light source requires for its mounting and heat transfer performance. Merging of two air flow paths is achieved by drawing air inward through both ends 164a and 164b of the heat sink exchange structure, in this case fins, and passing out through the top 166 of the enclosed volume of the heat exchange structure.

Dashed regions have been drawn to show the preferred locations of the restricting apertures. Dashed region 170 indicates the preferred location for an intake restricting aperture along the base of the heat sink fins 172 when a merging air path is employed. Dashed region 180 indicates the preferred location for the restricting aperture along the central top region of the heat exchange structure when a bifurcating air flow path is employed.

For systems which also employ a porous barrier layer, a bifurcating system (aka Pressure-Mode) of the current invention could place the porous barrier layer along the entire surface of both ends 182 of the heat exchange structure volume, while a merging system (aka Vacuum Mode) of the current invention could place the porous barrier layer along the entire top surface 184 of the heat exchange structure volume.

### Exemplar Air Cooling Systems

Referring to FIGS. 5-8, a first possible light fixture 20a with optimized cooling system is shown. The system includes a substantially H-shaped light weight frame 200 with a plurality (here 4) high temperature lights 202 operably secured thereto. The frame 200 includes channels 204 for transmitting fluid, such as air or the like, from an air source, such as a fan 40, to areas adjacent to the high temperature lights 202.

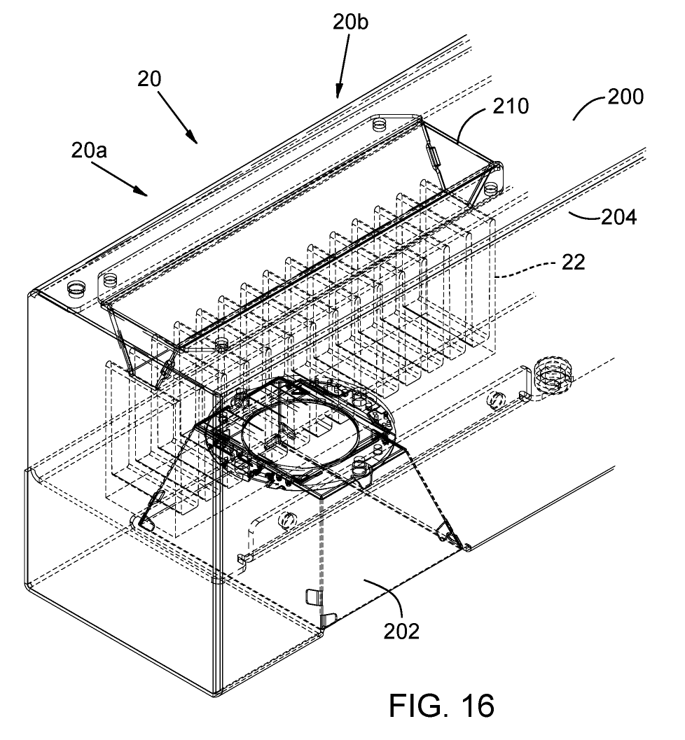

As best sown in FIG. 16, a heat sink 22 is operably positioned adjacent to each light 202 and fluid exit/entry ports 210 are provided in the frame to allow the cooling fluid to enter or exit the structure through the heat sink as previously described.

The heat sinks 22 increase the cooling ability of the fluid adjacent to the lights thereby allowing heat from the lights to be efficiently dissipated. The flow rate of the fan need not be particularly large since the heat sinks increase the velocity and turbulent flow adjacent to the lights.

Referring to FIGS. 9-16, and a second possible light fixture 20b with optimized cooling system is shown. This light fixture includes the basic elements of the first possible light fixture, so like elements have been like numbered to avoid undue repetition. It is shown having six lights 202 operably secured thereto with a heat sink 22 operably positioned in the flow path adjacent to each light.

In can be appreciated that the frame 200 may be enlarged as needed to accommodate as many lights as desired. The size, number and location of the air source such as a cooling fan may need to be adjusted to accommodate the heat load as needed.

The air source is preferably a fan operably secured to the system. It can be appreciated that cooling air may also be provided by directly tying the light fixture to an existing HVAC system in a building in which the light will be installed.

### Water Based Cooling System

Referring to FIGS. 17-19, a water-based cooling system for a light fixture 20c is disclosed. Referring to FIG. 17, the cooling system 250 may include a closed-loop water, or other liquid coolant, flow path that transmits cooling liquid to the light fixture 20c and cools the heated cooling liquid prior to its return to the light fixture. A pump 312 delivers cooling fluid from a reservoir 262 to the light fixture 20c. Heated cooling fluid is returned to the reservoir 262 after either passing by a heat exchanger 270 or after travelling through a cooling path 272 as shown.

Alternatively, if the cooling fluid is water, it can be exhausted to ambient after it has cooled the light fixture. Because of the improved heat exchange capabilities of the fixture, the volume of water flowing through the system needed to cool the light fixture is minimal.

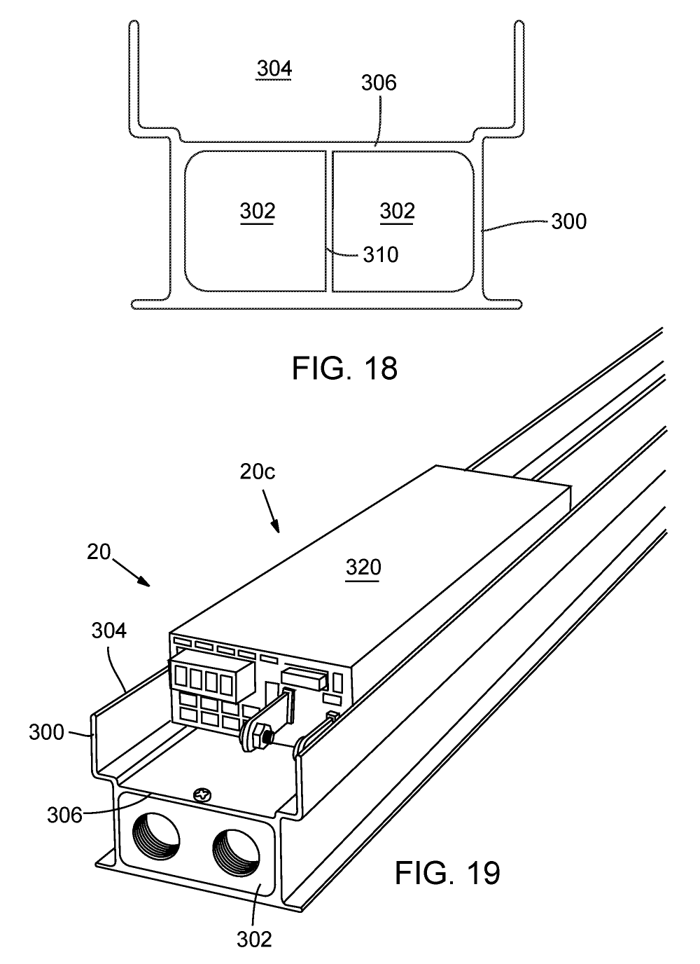

Referring to FIGS. 18 & 19, a water-based cooling liquid fixture frame 300 is shown. The frame 300 includes a water portion 302 for transmitting cooling water therethrough and an electronics mounting portion 304 for operably securing lighting electronics thereto. A thermally conductive and watertight wall 306 separates the water portion from the electronics mounting portion thereby defining a heat exchanger between the cooling water and the electronics such as high temperature lights operably secured within the electronics mounting portion.

Cooling liquid may flow through the fixture in one direction, or an interior wall 310 may be provided with an opening at one end of the fixture thereby allowing the cooling liquid to flow down one side of the water portion of the frame and return down the opposite side of the water portion.

Preferably, the frame 300 is formed of a continuous extrusion of a thermally conductive material such as aluminum. Cooling liquid is delivered to the water portion preferably by pump 312 or the like delivering the cooling fluid via a tube 280 running from the water source. Alternatively, if the cooling liquid is water in an open system, the water can be delivered by connecting a hose running from the light fixture to a water source such as a faucet or the like.

Preferably, the electronics 320 are detachably secured to the frame 300 for easy maintenance and cleaning. One possible attachment structure for the electronics can be spring bale clamps similar to re-useable canning jars provide a consistent clamping force which can be distributed by a clamping adapter matched to the LED array. In this case, the adapter is also a reflector cup to redirect the stray side light into the desire delivery cone angle. Electrical power for the lights and the like can be positioned along the electronics mounting portion as needed. This same structure could also support a lightweight floating ceiling that could move up and down with the light to adjust according to plant height needs.

### Use, Operation and Additional Features and Benefits

Having described the physical features of the invention, its use, benefits and features can include allowing for a complete, stand-alone product with a sales price of less than one dollar per watt for low volume, local based manufacturing. This first product offering delivers a true 300 watts of LED powered illumination with a product weight of less than 7.5 pounds, including the six-foot power cord and full steel enclosure. Future versions can be designed to achieve much lower costs and weights, especially when applied to large scale operations with full HVAC systems. A preferred embodiment could reach costs of less than $0.40 per watt and fixture weights of less than half a pound per 100 watts.

The primary intended application will be for all types of indoor growing operations, especially the emerging medical and recreational marijuana industries. Customers could be both businesses and private parties, in particular, the first 300-watt product version has been developed to address personal and small commercial operations. The current invention will maximize lighting energy efficiency and minimize operating costs for indoor growing operations.

This invention can enable at least four different modes of operation:

First, a stand-alone product can be created using a vacuum-mode system where the plenum or ductwork enclosure is connected to the input side of the air moving device and room air is used for the return air flow path. This arrangement minimizes dust build-up on the light emitting surfaces and thoroughly mixes the outgoing hot air to minimize the creation of any localized hot surfaces. In this case, the air flow also stops when the lights go out so no dust is moved during dark periods.

Second, a network of many light sources each attached to heat sinks can be effectively cooled together by a pressure-mode system where the plenum or ductwork enclosure is connected to the output side of the air moving device and room air is used for the return vacuum leg of the air flow path. This preferred embodiment allows a single large fan to cool a large plurality of light sources altogether. This air could be pre-filtered and pre-conditioned such as is done for HVAC systems now and that could solve the dust build-up issue even better than vacuum-mode systems. It could also be quieter and cheaper to operate.

Third, a second return-leg plenum or ductwork enclosure could be added to make the system a closed loop circuit. In this case, the cooling air flow could be kept separate from the room air for situations where that is an advantage. Examples of this include when CO2 enhancement is used to boost growth rates or when rooms are kept sealed to avoid tiny pests getting in.

Fourth, a liquid could be used instead of air as the cooling fluid. A preferred embodiment has also been created for this application using a continuous aluminum extrusion structure.

One additional advantage is that the product footprint can be minimized to enable use in greenhouses. By having the smallest footprint possible, the additional lighting does not block the natural sunlight.

One skilled in the relevant art will recognize that numerous variations and modifications may be made to the configurations described above without departing from the scope of the present invention, as defined by the appended claims. For example, while the primary preferred embodiment is a miniaturized vacuum-mode system intended to function as a stand-alone product for private consumers, another preferred embodiment is created when a full network of pressurized plenum air flow distribution is coupled with electrical power distribution to many heat sinks with light sources attached. In this way, the cooling air could be filtered and clean to avoid the problem of pulling airborne contaminants, like moisture and dust, into the lighting components. Ideally filtered and conditioned HVAC air flow could be used and in this way both the air flow and light could be completely and evenly distributed by a single network structure.

Another preferred embodiment is created when a second enclosure or duct work network is added to provide a closed loop fluidic cooling system where it is desirable to not mix it with the existing grow room air, such as with carbon dioxide enhancement.

What is claimed is:

1. A light fixture with cooling system having:
a frame;
a light operably secured to the frame;
a fluid chamber within the frame for receiving a flow of cooling fluid therethrough;
a cooling fluid source for delivering the flow of cooling fluid to the fluid chamber; and,
a heat sink operably engaging the light and fluid chamber such that cooling fluid flowing through the fluid chamber operably engages the heat sink to cool the light.

2. The light fixture with cooling system of claim 1, wherein the cooling fluid is air and the cooling fluid source is an air flow generator, and further including:
a plenum operably received within the flow path for channeling the flow of air to flow between the heat sink and the air flow generator;
a restricting aperture in said plenum wherein the velocity of air increases as its pressure drops because of the flow of air going through said restricting aperture; and,
the heat sink is thermally secured to the light with an air flow heat exchange structure positioned adjacent to said restricting aperture whereby the air flow must change direction in a turbulent manner within the confines of the heat exchange structure; and,
a power source for driving the light source and the air flow generator.

3. The cooling system in claim 2, wherein the lighting source is a Light Emitting Diode (“LED”).

4. The cooling system in claim 2, wherein the heat exchange structure is comprised of parallel fins.

5. The cooling system in claim 4, wherein the heat sink has a wide flat area with fins extending therefrom.

6. The cooling system in claim 2, wherein the aperture is a narrow slot positioned along the entire width of the heat sink.

7. The cooling system in claim 1, wherein the heat sink is extruded metal cut into lengths that are shorter than their extruded widths.

8. The cooling system in claim 5, wherein the fins are textured for greater heat transfer.

9. The cooling system in claim 2, further including a secondary porous boundary layer added across an air flow exit face of the heat exchange volume thereby providing slight air flow resistance for evenly distributing the air exhaust velocity and increasing the heat transfer performance by increasing the average air dwell time within the heat exchange structure.

10. The cooling system in claim 2, wherein a single flow of air bifurcates into two flows within the confines of the heat exchange structure and allows the air to flow bilaterally out both ends of the heat exchange structure.

11. The cooling system in claim 10, wherein a pair of apertures arranged one on each end of the heat exchange structure in a bilateral pattern are used to create two air flows that merge into a single air flow within the confines of the heat exchange structure and exits through the top of the heat exchange structure.

12. The cooling system in claim 2, wherein there is a plurality of heat sinks, each with their own air flow aperture delivering air to its own heat exchange structure and each with one or more light sources attached in a thermally conductive manner.

13. The light fixture with cooling system of claim 1, wherein the cooling fluid is liquid.

14. The light fixture with cooling system of claim 13, wherein the cooling fluid is selected from the group consisting of water and coolant.

15. The light fixture with cooling system of claim 13, wherein the frame is formed of a continuous extruded material defining a fluid portion and an electronics portion with a thermally conductive wall therebetween.

16. The light fixture with cooling system of claim 15, wherein the continuous extruded material is aluminum.

17. The light fixture with cooling system of claim 15, further including a wall extending along the fluid portion thereby defining two flow paths within the fluid portion.

18. The light fixture with cooling system of claim 15, further including a closed fluid path circulating through the light fixture.

19. The light fixture with cooling system of claim 15, wherein the fluid path exhausts to ambient.
